(19) United States
(12) Patent Application Publication
(10) Pub. No.: US 2024/0279128 A1
(43) Pub. Date: Aug. 22, 2024

(54) Methods for Joining Composite Components to Form a Unitary Composite Component

(71) Applicant: General Electric Company, Schenectady, NY (US)

(72) Inventors: Joseph John Shiang, Niskayuna, NY (US); Jared Hogg Weaver, Clifton Park, NY (US); Jerome Geoffrey Magnant, Rexford, NY (US); Daniel Gene Dunn, Guilderland, NY (US)

(21) Appl. No.: 18/170,059

(22) Filed: Feb. 16, 2023

(51) Int. Cl. C04B 41/00; C04B 41/50; C04B 41/52; C04B 41/89

(52) U.S. Cl. CPC C04B 41/009; C04B 41/0072; C04B 41/5024; C04B 41/52; C04B 41/89; C04B 2111/00224; C04B 2111/1087

(57) ABSTRACT

Methods for joining a first ceramic component to a second ceramic component to form a unitary ceramic component are provided. The method includes positioning a bonding sheet between a first ceramic component and a second ceramic component. The bonding sheet defines a plurality of voids. The method also includes densifying the bonding sheet with an infiltrate composition at a densification temperature to form a bonding interface comprising a ceramic material that forms a bonding interface between the first ceramic component to the second ceramic component into a unitary ceramic component.

### FIELD

The present subject matter relates generally to joining composite components together, along with the resulting unitary composite components.

### BACKGROUND

More commonly, ceramic components are being used in various applications, such as gas turbine engines. In particular, ceramic matrix composite (CMC) materials are more frequently being used for various high temperature applications. For example, because CMC materials can withstand relatively extreme temperatures, there is particular interest in replacing components within a combustion gas flow path of a gas turbine engine with components made from CMC materials. Plies of the CMC material may be laid up to form a preform component that may then undergo thermal and/or chemical processing to arrive at a component formed of a CMC material having a desired chemical composition.

### BRIEF DESCRIPTION OF THE DRAWINGS

A full and enabling disclosure of the present disclosure, including the best mode thereof, directed to one of ordinary skill in the art, is set forth in the specification, which makes reference to the appended Figs., in which:

FIG. 1 shows a cross-sectional schematic view of an exemplary ceramic component including a ceramic material formed from a densified bonding sheet that forms a bonding interface between a first ceramic component to a second ceramic component to form a unitary component;

FIG. 2 shows a cross-sectional schematic view of another exemplary ceramic component including a ceramic material formed from a densified bonding sheet that forms a bonding interface between a first ceramic component to a second ceramic component to form a unitary component;

FIG. 3 shows a perspective schematic view of an exemplary bonding sheet that forms a bonding interface between a first ceramic component and a second ceramic component to form a unitary component;

FIG. 4 shows a cross-sectional schematic view of a unitary ceramic component including a ceramic material that forms a bonding interface between a first ceramic component to a second ceramic component; and

FIG. 5 shows a flow chart diagram of a method of forming a unitary ceramic component according to an exemplary embodiment of the present disclosure.

Repeat use of reference characters in the present specification and drawings is intended to represent the same or analogous features or elements of the present disclosure.

### DEFINITIONS

As used herein, the word “exemplary” is means “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The singular forms “a”, “an”, and “the” include plural references unless the context clearly dictates otherwise.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

A “densified ceramic component” is a ceramic having less than 70 vol % porosity. Additionally, the densified ceramic component is in a finished state that will not undergo additional processing steps aimed at improving its mechanical properties. Usually, a densified ceramic component has a mechanical stress above 20 MPa, as measured by a 3 point bending test according to ASTM C1161-18.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), carbon, oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC-SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing and subsequent chemical processing to arrive at a component formed of a CMC material having a desired chemical composition. For example, the preform may undergo a cure or burn-out to yield a high char residue in the preform, and subsequent melt-infiltration with silicon, or a cure or pyrolysis to yield a silicon carbide matrix in the preform, and subsequent chemical vapor infiltration with silicon carbide. Additional steps may be taken to improve densification of the preform, either before or after chemical vapor infiltration, by injecting it with a liquid resin or polymer followed by a thermal processing step to fill the voids with silicon carbide. CMC material as used herein may be formed using any known or hereinafter developed methods including but not limited to melt infiltration, chemical vapor infiltration, polymer impregnation pyrolysis (PIP), or any combination thereof.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer.

The term “unitary” as used herein denotes that the final component has a construction in which the integrated portions are inseparable and is different from a component comprising a plurality of separate component pieces that have been joined together but remain distinct and the single component is not inseparable (i.e., the pieces may be re-separated). Thus, unitary components may comprise generally substantially continuous pieces of material or may comprise a plurality of portions that are permanently bonded to one another. In any event, the various portions forming a unitary component are integrated with one another such that the unitary component is a single piece with inseparable portions.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Large ceramic components or parts with complex geometry can be difficult to fabricate in a single piece and/or at an acceptable yield. This includes CMC components as well as other ceramic materials. As such, improved methods of fabricating ceramic components are desired.

The present disclosure is generally directed to methods for forming a unitary ceramic component by joining at least two ceramic components together (e.g., a first ceramic component to a second ceramic component, and optionally to a third ceramic component, etc.). The resulting unitary ceramic component has a unified construction in which the integrated portions are inseparable and permanently bonded to one another to form a continuous component. Thus, such a unitary composite component is different from a bonded component comprising separate component pieces that have been joined together but remain distinct with the component pieces being separable (i.e., the pieces may be re-separated). Thus, unitary components may comprise generally substantially continuous pieces of material or may comprise a plurality of portions that are permanently bonded to one another. In any event, the various portions forming a unitary ceramic component are integrated with one another such that the unitary component is a single piece with inseparable portions. Thus, the resulting unitary ceramic component may be utilized as a unitary component while being formed in a process that allows more complex shapes to be more easily formed (e.g., without complicated ply layup processes).

In general, the method for forming the unitary ceramic component includes the use of a bonding sheet in a bonding interface between a first ceramic component and a second ceramic component. The bonding sheet serves as a scaffold to grow a ceramic material in the bonding interface through a chemical vapor infiltration (“CVI”) process. Additionally, the bonding sheet defines a plurality of vapor pathways therein, such as in the form of voids and/or channels discussed in greater detail below. Thus, the vapor pathways allow for an infiltrate composition to penetrate the bonding sheet during the CVI process, as well as acting as a scaffold for ceramic growth. Conversely, the plurality of vapor pathways allows for gaseous reaction products (when formed) to escape from the bonding sheet. Thus, the ceramic material can be formed throughout the entire thickness and/or length of the bonding interface between the adjacent ceramic components. Through these methods, the unitary ceramic component includes a joint formed from a densified bonding sheet between adjacent ceramic components.

Aspects of the present disclosure may offer a number of advantages over conventional ceramic component joining methods and joints. For example, the bonding sheet of the present disclosure may include a polymeric film or a fabric having a precisely controlled architecture, composition, or both. For instance, the dimensions of any voids and the spacing between voids in the bonding sheet may be strategically and precisely controlled, allowing for densification of the bonding sheet to be improved. Thus, the use of a bonding sheet can provide for a controlled application and/or controlled bond-line thickness. In this regard, the quality of the resulting joint between two ceramic substrates may be improved to be more uniform and formed more predictably.

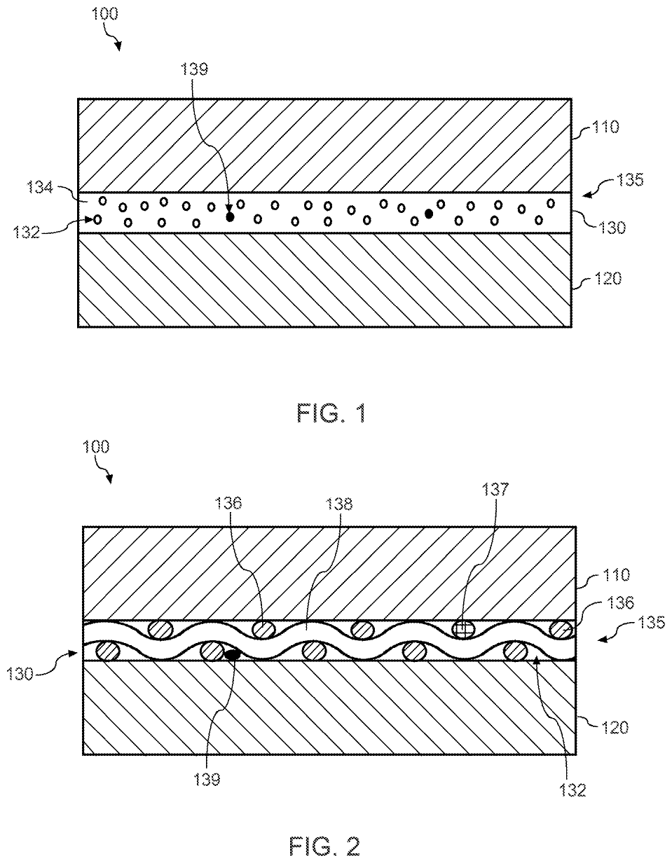

Referring now to the drawings, wherein identical numerals indicate the same elements throughout the figures, FIGS. 1 and 2 show a schematic cross-sectional view of exemplary ceramic component precursor 100. The ceramic component precursor 100 includes a first ceramic component 110 and a second ceramic component 120. In one embodiment, the first ceramic component 110 contains a first ceramic material and the second ceramic component 120 contains a second ceramic material. For example, the first ceramic component 110, the second ceramic component 120, or both may be a ceramic matrix composite (“CMC”). For instance, the first ceramic component 110 may contain a first ceramic matrix composite material, and the second ceramic component 120 may contain a second ceramic matrix composite material.

A bonding sheet 130 is positioned in a bonding interface 135 between the first ceramic component 110 and the second ceramic component 120. The bonding sheet 130 includes a plurality of voids 132 therein. The bonding sheet 130 may be a film or fabric that includes the plurality of voids 132 therein. For example, suitable fabrics may include a woven fabric, a knit fabric, a braided fabric, or a non-woven fabric (e.g., a ceramic felt). In the embodiment where the bonding sheet 130 is a ceramic felt, the compressibility of such a ceramic felt avoids the necessity of strict dimensional requirements (which requires expensive machining) of the ceramic components being joined. When utilized, such a compressible felts allow for dimensional mismatch of the first ceramic component and the second ceramic component, which may eliminate the need for expensive and difficult machining to obtain high tolerance mating surfaces.

In the embodiment, of FIG. 1, for instance, the bonding sheet 130 is shown as a film 134 with a plurality of voids 132 dispersed therein. For example, the bonding sheet 130 may be a polymeric film that is perforated to include a plurality of voids 132 therein. In one embodiment, the polymeric film may include a matrix precursor such as organic or inorganic material that leaves char/residue after burn out, such as pyrolysis or firing. For example, the char may serve as an adhesive holding the joint together prior to densification (e.g., CVI densification), which may avoid the necessity of any tool to hold the two components together after burn out but before densification. In some embodiments, the matrix precursor may include a silicon containing precursor operable, as described below, for forming a porous silicon containing precursor such as silicon carbide. Examples of a matrix precursor include preceramic polymers (such as a polysilane, a polycarbosilane, a polysilazane, a polysiloxane, or a mixture thereof), or carbon char yielding materials, or mixtures thereof. Thus, in one aspect, the polymeric film may be heated to convert the polymeric film into a preform film having at least one void, at least one channel, or a mixture thereof.

In the embodiment of FIG. 2, the bonding sheet 130 is shown as a fabric including a plurality of fibers 136, either woven or nonwoven, and defining voids 132 in the interspatial areas between adjacent fibers 136. In the embodiment shown, the fabric includes a plurality of first fibers 136 woven with a plurality of second fibers 138 and defining voids 132 in the interspatial areas between adjacent fibers 136, 138. This plurality of voids 132 may work together to serve as vapor pathways defined within the bonding sheet 130. The plurality of first fibers 136, a plurality of second fibers 138, or both may generally include a wide variety of compounds that have the ability to survive a high temperature thermal process in an aggressive chemical atmosphere, such as a chemical vapor infiltration process. However, the compounds in the plurality of first fibers 136, a plurality of second fibers 138, or both are preferably selected to be chemically and/or thermodynamically compatible with the first ceramic component 110, the second ceramic component 120, or both. Thus, in one aspect, the plurality of first fibers 136, a plurality of second fibers 138, or both may include carbon, a ceramic (e.g., silicon carbide), or a mixture thereof.

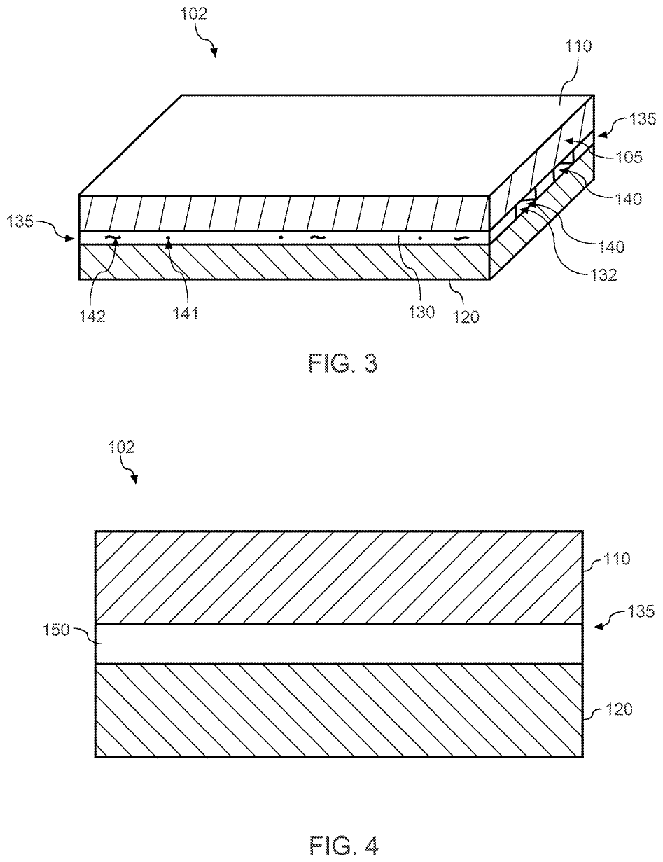

Additionally, in one particular embodiment, the bonding sheet 130 may include at least one sacrificial fiber 137 that is configured to be removed prior to or during CVI densification. In one embodiment, the at least one sacrificial fiber 137 may be removed prior to the CVI processing, such as through melting, chemical etching/leaching, volatilization, or physical extraction. For instance, inorganic silicate glasses, borate glasses, aluminate glasses, or mixtures thereof may be removed by melting or chemical etching. Such glasses may be doped, in particular embodiments, with other ions such as sodium, potassium or magnesium to further adjust the melting point. Metallic fibers can also be incorporated and can then be removed by use on an appropriate oxidizing acid, such as HNO₃, H₂SO₄, or mixtures thereof. Alternatively, in one embodiment, the at least one sacrificial fiber 137 is configured to vaporize during the CVI process to form vapor channels where the sacrificial fiber 137 was initially positioned. For example, the at least one sacrificial fiber 137 may define an area of the fabric that is fugitive (i.e., configured to evaporate, deteriorate, or otherwise disappear) upon heating the bonding sheet 130 to facilitate the formation of at least one channel 140 (FIG. 3) in the bonding sheet 130. Thus, the at least one sacrificial fiber 137 may provide a precisely controlled pathways for densification to be imparted into the bonding sheet 130. Thus, in one aspect, the bonding sheet 130 of the present disclosure may be heated to burn out the at least one sacrificial fiber 137 to form a channel 140 therein. Examples of the at least one sacrificial fiber 137 may include fibers containing a polymeric material (e.g., polyvinyl butyral, polyethylene, polypropylene, polyamide, nylon, polytetrafluoroethylene (PTFE), polystyrene, polyvinyl acetate, polyvinyl alcohol), a cellulosic material, or combinations thereof.

Void(s) 132, channel(s) 140 or both may also be formed by melting out particles or through chemical reactions, such as a chemical reaction reacting silicon particles in the joint with carbon particles in the joint to form silicon carbide, which is a reaction that is associated with a volume reduction. An example of melting could be melting Si particles from the joint and having the Si pulled out of the joint and into a fine pore structure in one of the ceramic pieces being joined. Since Si melts above the temperature used for many CVI processes, a separate thermal step may be performed prior to CVI.

Referring to FIGS. 1 and 2, the bonding sheet 130 may include a plurality of pore-forming particles 139, which may be fugitive (i.e., configured to evaporate, deteriorate, or otherwise disappear) upon heating the bonding sheet 130. The plurality of pore-forming particles 139 may facilitate the formation of at least one void 132 in the bonding sheet 130, providing further controlled pathways for densification to be imparted into the bonding sheet 130. Thus, in one aspect, the bonding sheet 130 of the present disclosure may be heated to burn out pore-forming particles 139 and form at least one void 132 in the bonding sheet 130. Examples of pore-forming particles 139 may include particles containing polyvinyl butyral, polyethylene, polypropylene, polyamide, nylon, polytetrafluoroethylene (PTFE), polystyrene, polyvinyl acetate, polyvinyl alcohol, and/or cellulosic powders.

The plurality of voids 132, the pore-forming particles 139, and/or at least one sacrificial fiber 137 (FIGS. 1 and 2) may form at least one channel 140 in a resulting unitary ceramic component 102 upon heating of the bonding sheet 130 as shown in FIG. 3. As shown, the at least one channel 140 may generally extend from an edge 105 of the unitary ceramic component 102 into the bonding interface 135. In such an embodiment, the at least one channel 140 allows for transport of an infiltrate composition to penetrate the bonding sheet 130 during a densification process (e.g., a CVI process). Conversely, the at least one channel 140 allows for gaseous reaction products (when formed) to escape from the bonding sheet 130.

No matter the configuration of the bonding sheet 130 in the bonding interface 135, densifying the bonding sheet 130 results in the formation of a ceramic material 150, as shown in the unitary ceramic component 102 of FIG. 4.

In one embodiment, the bonding sheet 130 may include particles 141 (e.g., ceramic particles, metal particles, or a mixture thereof), discontinuous fibers 142 (e.g., chopped fibers, whiskers, or other forms of discontinuous fibers, which may be ceramic discontinuous fibers, metal discontinuous fibers, or a mixture thereof) as shown in FIG. 3. For example, ceramic particles 141, discontinuous fibers 142, or a mixture thereof may be employed in the bonding sheet 130 to help control shrinkage of the bonding sheet 130 during processes. Additionally, the ceramic particles 141, discontinuous fibers 142, or a mixture thereof may provide surfaces for infiltrating fluid to grow silicon carbide thereon, as is the case with the continuous fibers discussed above with respect to the woven or non-woven sheets of the bonding sheet 130. Examples for compounds in the ceramic particles 141, discontinuous fibers 142, or a mixture thereof may include, SiC, C, B₄C, SiO₂, HfC, HfB₂, ZrC, ZrB₂, MoSi₂, Si₃N₄, AL₂O₃, rare earth silicates, rare earth silicides, or mixtures thereof

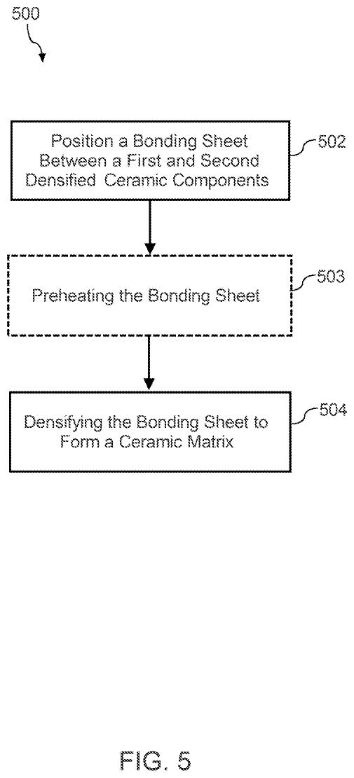

Referring now to FIG. 5, a flow chart diagram is provided for a method 500 of forming a unitary ceramic component. At 502, the method includes positioning a bonding sheet between a first ceramic component and a second ceramic component, as discussed above with respect to FIGS. 1-4. At 504, the method further includes densifying the bonding sheet to form a ceramic material that forms a bonding interface between the first ceramic component to the second ceramic component and forming a unitary ceramic component. During densification of the bonding sheet, an infiltrate composition may flow into the voids and channels of the bonding sheet to react with materials therein to form the ceramic material. For example, the infiltrate composition may include a vapor or a molten material as used in various densification processes described herein. As discussed, the bonding sheet may include a matrix precursor such as organic or inorganic material that leaves char/residue after burn out, such as pyrolysis or firing, as well as other fillers such as ceramic particles or ceramic fibers.

For example, the infiltrate composition may flow from an edge of the unitary ceramic component and into the bonding sheet via at least one of a void, a channel, or both, to penetrate the bonding sheet and fill any voids and/or channels therein. As such, the infiltrate composition may densify the bonding sheet by filling the voids and/or channels with ceramic-forming material during densification. Thus, densifying the bonding sheet results in the formation of a densified bonding sheet, included in a ceramic material that forms a bonding interface between the first ceramic component to the second ceramic component. In one aspect, the infiltrate composition may include silicon, carbon, boron, or a mixture thereof (e.g., silicon carbide, a carbon-containing composition, etc.).

Specific processing techniques and parameters for densification can depend on the particular composition of the materials. In exemplary embodiments, densifying the bonding sheet includes using a chemical vapor infiltration process, whereby a matrix material is infiltrated into the bonding sheet by the use of reactive gases at elevated temperature to form the densified bonding sheet.

For example, reactive gases may include, but are not limited to, hydrocarbon gases (e.g., methane, propane, acetylene, etc.), carbon and silicon containing precursor gases (e.g., methyl-trichlorosilane, etc.), chlorine-containing boron and silicon precursor gases (e.g., boron trichloride, trichloro-silane, etc.), nitrogen-containing precursor gases (e.g., ammonia gas), or mixtures thereof. Etchant gases, such as HCl, may also be present to modify the deposition surface before or during any point of the CVI process. In one embodiment, infiltrating metals, such as platinum and/or aluminum may be introduced via, for example, their respective acetylacetonate complexes or via their respective metal chlorides.

Other vapor phase densification methods may be utilized, such as atomic layer deposition (e.g., of materials such as Al₂O₃ and HfO₂) in which, for example, alternating layers of a metal precursor (e.g., methyl aluminum) are alternated with an oxygen source (e.g., oxygen, water, etc.) to deposit a layer-by-layer infiltrated film. This method can be combined with other methods. For example, a first coating may be applied via atomic layer deposition to prepare (e.g., “prime”) the bonding surfaces and then the remainder of the bond film may be densified.

In one embodiment, the bonding sheet may be densified using the chemical vapor infiltration process alone or using a combination of a partial chemical vapor infiltration followed by melt infiltration or a combination of a slurry infiltration followed by melt infiltration. For example, melt infiltration may introduce silicon (Si), a silicon alloy, or a silicon oxide, such as rare-earth disilicates (RE₂Si₂O₇), or using slurry infiltration prior to melt infiltration. Other densification techniques include, but are not limited to, silicon melt infiltration processes and reactive melt infiltration processes, PIP processes (e.g., the porous structure of the bonding sheet is infiltrated with a preceramic polymer, such as polysilazane and then heat treated to form a SiC matrix) and oxide/oxide processes (e.g., for aluminum or alumino-silicate reinforcement material components), which each may be used alone or in combination with one or more other densification processes.

Optionally, the method 500 may include pre-heating the bonding sheet at 503 so as to burn out at least one of a plurality of sacrificial fibers, sacrificial particles, or both and resulting in a channels, voids, or both being forming in the bonding sheet. As discussed, pore-forming particles and pore-forming fibers may be employed in the bonding sheet to define an area of portion of the bonding sheet that is fugitive upon heating. Thus, in one aspect, the method further includes preheating the bonding sheet to form a plurality of voids and/or channels in the bonding sheet.

In some embodiments, the pore structure in the bonding layer prior to the CVI infiltration step has a distribution of shapes. For instance, the pore structure may include a set of relatively fine pores combined with a series of crack-like pores where the long axis of the pore is perpendicular to the plane of the join. In particular embodiments, a vertical crack may extend into the center of the bonding interface. In some embodiments, the width of such a vertical crack may be less than the joint thickness and from 20 to 400 times smaller than the length of the crack in the plane of the joint.

In some embodiments, the either both or one of the two ceramic components being joined with the bonding sheet can be a non-densified ceramic prior to the densification of the bonding sheet and can be densified at the same time as the bonding sheet.

Accordingly, as described herein, the present subject matter provides for improved joints between ceramic matrix composite substrates and methods of forming the same. For instance, CMC components with complex geometries can be difficult to fabricate in monolithic pieces or at an acceptable yield. Thus, a number of methods of joining CMC substrates have been developed to produce bulk, CMC components, such as methods of preceramic joining. Methods of preceramic joining generally include applying an organosilicon polymer slurry in between two CMC substrates that are to be bonded together. A pyrolytic decomposition process is then performed on the organosilicon polymer slurry, transforming it into a preform which includes a silicon carbide precursor and a plurality of voids. Thereafter, the preform may be densified using methods including chemical vapor infiltration and melt infiltration. However, the bonding interface formed in preceramic joining includes a plurality of voids with dimensions and void spacing that is generally unable to be precisely controlled.

Conversely, the methods and joints of the present disclosure provide for a joint in between two ceramic substrates having an improved quality. Specifically, the features of the voids in the bonding sheet of the present disclosure, which act as fluid pathways during densification, may be precisely controlled. In one example aspect, the features of the voids in the bonding sheet are precisely controlled along the length and depth of the bonding sheet. Thus, “choking off” infiltration pathways and preventing densification of inner portions of the preform may be minimized or prevented entirely. Thus, densification of the joint and its resulting quality may be improved, as the bonding sheet of the present disclosure provides for a more uniform, predictable scaffold for infiltrating fluid. Moreover, the bonding sheet of the present disclosure provides for improved bondline thickness control.

Further aspects are provided by the subject matter of the following clauses:

A method comprising: positioning a bonding sheet between a first ceramic component and a second ceramic component, wherein the bonding sheet defines a plurality of voids; and densifying the bonding sheet with an infiltrate composition at a densification temperature to form a bonding interface comprising a ceramic material that forms a bonding interface between the first ceramic component to the second ceramic component into a unitary ceramic component.

The method of any preceding clause, wherein the first ceramic component is a first densified ceramic component prior to positioning the bonding sheet in the bonding interface, and wherein the second ceramic component is a second densified ceramic component prior to positioning the bonding sheet in the bonding interface.

The method of any preceding clause, wherein the infiltrate composition comprises silicon, carbon, boron, or a mixture thereof.

The method of any preceding clause, wherein the bonding sheet is positioned between an entire bonding interface defined between the first ceramic component and the second ceramic component.

The method of any preceding clause, wherein the densifying the bonding sheet includes performing chemical vapor infiltration on the bonding sheet with the infiltrate composition.

The method of any preceding clause, wherein the bonding sheet comprises a fabric.

The method of any preceding clause, wherein the bonding sheet comprises a fabric having a plurality of fibers, and wherein the plurality of fibers comprises carbon, silicon carbide, or a mixture thereof.

The method of any preceding clause, wherein the plurality of fibers comprises at least one sacrificial fiber and at least one ceramic fiber.

The method of any preceding clause, wherein the at least one sacrificial fiber is dissipated prior to or during densifying the bonding sheet to define fluid channels within the bonding sheet.

The method of any preceding clause, wherein the at least one ceramic fiber remains within the ceramic material.

The method of any preceding clause, wherein the fabric comprises a woven fabric of the plurality of fibers with porosity defined between the plurality of fibers defining the plurality of voids.

The method of any preceding clause, wherein the bonding sheet comprises a non-woven fabric of the plurality of fibers with porosity defined between the plurality of fibers defining the plurality of voids.

The method of any preceding clause, wherein the bonding sheet comprises a ceramic felt.

The method of any preceding clause, wherein the bonding sheet comprises a polymeric film with the plurality of voids defined therein.

The method of any preceding clause, wherein the bonding sheet comprises ceramic particles, discontinuous fibers, or a mixture thereof.

The method of any preceding clause, wherein positioning a bonding sheet comprises positioning a plurality of bonding sheets between the first ceramic component and the second ceramic component.

The unitary ceramic component formed according to the method of any preceding clause.

A unitary ceramic component comprising: a first densified ceramic component; a second densified ceramic component; and a ceramic material bonding the first densified ceramic component to the second densified ceramic component, wherein the ceramic material comprises a densified bonding sheet.

The ceramic component of any preceding clause, wherein the densified bonding sheet comprises a woven fabric or a nonwoven fabric.

The ceramic component of any preceding clause, wherein the nonwoven fabric comprises a ceramic felt.

The ceramic component of any preceding clause, wherein the densified bonding sheet comprises ceramic particles, discontinuous fibers, or a combination thereof.

The ceramic component of any preceding clause, wherein the ceramic material includes an infiltrate composition comprises silicon, silicon and a boron-containing species, a silicon-boron alloyed compound, or a mixture thereof.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method comprising:
positioning a bonding sheet between a first ceramic component and a second ceramic component, wherein the bonding sheet defines a plurality of voids; and
densifying the bonding sheet with an infiltrate composition at a densification temperature to form a bonding interface comprising a ceramic material that forms a bonding interface between the first ceramic component and the second ceramic component into a unitary ceramic component.

2. The method of claim 1, wherein the first ceramic component is a first densified ceramic component prior to positioning the bonding sheet in the bonding interface, and wherein the second ceramic component is a second densified ceramic component prior to positioning the bonding sheet in the bonding interface.

3. The method of claim 1, wherein the infiltrate composition comprises silicon, carbon, boron, or a mixture thereof.

4. The method of claim 1, wherein the bonding sheet is positioned between an entire bonding interface defined between the first ceramic component and the second ceramic component.

5. The method of claim 1, wherein the densifying the bonding sheet includes performing chemical vapor infiltration on the bonding sheet with the infiltrate composition.

6. The method of claim 1, wherein the bonding sheet comprises a fabric.

7. The method of claim 1, wherein the bonding sheet comprises a fabric having a plurality of fibers, and wherein the plurality of fibers comprises carbon, silicon carbide, or a mixture thereof.

8. The method of claim 7, wherein the plurality of fibers comprises at least one sacrificial fiber and at least one ceramic fiber.

9. The method of claim 8, wherein the at least one sacrificial fiber is dissipated prior to or during densifying the bonding sheet to define fluid channels within the bonding sheet.

10. The method of claim 8, wherein the at least one ceramic fiber remains within the ceramic material.

11. The method of claim 7, wherein the fabric comprises a woven fabric of the plurality of fibers with porosity defined between the plurality of fibers defining the plurality of voids.

12. The method of claim 1, wherein the bonding sheet comprises a non-woven fabric of the plurality of fibers with porosity defined between the plurality of fibers defining the plurality of voids.

13. The method of claim 1, wherein the bonding sheet comprises a ceramic felt.

14. The method of claim 1, wherein the bonding sheet comprises a polymeric film with the plurality of voids defined therein.

15. The method of claim 1, wherein the bonding sheet comprises ceramic particles, discontinuous fibers, or a mixture thereof.

16. The method of claim 1, wherein positioning a bonding sheet comprises positioning a plurality of bonding sheets between the first ceramic component and the second ceramic component.

17. A unitary ceramic component comprising:
a first densified ceramic component;
a second densified ceramic component; and
a ceramic material bonding the first densified ceramic component to the second densified ceramic component, wherein the ceramic material comprises a densified bonding sheet.

18. The ceramic component of claim 17, wherein the densified bonding sheet comprises a woven fabric or a nonwoven fabric.

19. The ceramic component of claim 17, wherein the densified bonding sheet comprises ceramic particles, discontinuous fibers, or a combination thereof.

20. The ceramic component of claim 17, wherein the ceramic material includes an infiltrate composition comprising silicon, silicon and a boron-containing species, a silicon-boron alloyed compound, or a mixture thereof.
